(19) United States
(12) Patent Application Publication
(10) Pub. No.: US 2015/0131442 A1
(43) Pub. Date: May 14, 2015

(54) Dynamic Profiling for Transport Networks

(71) Applicants: Sándor Rácz, Cegled (HU); Balázs Gerö, Budapest (HU); János Harmatos, Budapest (HU); Szilveszter Nádas, Budapest (HU)

(72) Inventors: Sándor Rácz, Cegled (HU); Balázs Gerö, Budapest (HU); János Harmatos, Budapest (HU); Szilveszter Nádas, Budapest (HU)

(73) Assignee: Telefonaktiebolaget L M Ericsson (publ), Stockholm (SE)

(21) Appl. No.: 14/398,743

(22) PCT Filed: May 8, 2012
(86) PCT No.: PCT/EP2012/058463

§ 371 Date: Dec. 23, 2014

(51) Int. Cl. H04W 28/02; H04W 28/20; H04L 12/823

(52) U.S. Cl. CPC H04W 28/0257; H04L 47/32; H04W 28/20
USPC 370/235

(57) ABSTRACT

A method is provided for transporting data packets over a telecommunications transport network. The data packets are carried by a plurality of bearers, and are sent over the transport network from a serving node. Information is received relating to a current capacity of the transport network. A current maximum total information rate for the serving node is dynamically adjusted based on information relating to a current capacity of the transport network. A current maximum information rate for each of the bearers is determined based on the current maximum total information rate. Bandwidth profiling is applied to the data packets of each of the bearers, independently of the other bearers, to identify the data packets of each of the bearers that are conformant with the determined current maximum information rate for the bearer. The data packets are forwarded for transport through the transport network. If there is insufficient bandwidth available in the transport network, data packets not identified by the profiling as being conformant are discarded.

### TECHNICAL FIELD

The present invention relates to improvements in the handling of data communications transmitted across a transport network.

### BACKGROUND

A transport network (TN) is used to carry data signals between a Radio Base Station (RBS), such as a NodeB or an eNodeB in 3G Long-Term Evolution (LTE) networks, and a Radio Access Network (RAN) entity such as a Radio Network Controller (RNC), Serving gateway (S-GW) or Packet Data Network gateway (PDN-GW). A TN may be operated by a mobile network operator or by a third party transport provider. In the latter case there would be a Service Level Agreement, SLA, between the mobile and transport operators. With the rapid growth of digital data telecommunications following the introduction of 3G and 4G technology, TNs may frequently act as bottlenecks in the overall data transport process. Thus, various systems and methods have been proposed for improving or prioritising the way that data packets are transported by the bearers.

Service differentiation in the RAN is one supplementary means for more efficiently handling high volumes of traffic. As a simple example, using service differentiation a higher bandwidth share can be provided for a premium service, and in this way the overall system performance can be improved. As another example, a heavy service such as p2p traffic, can be down-prioritized. Implementing such service differentiation methods requires integration into the Quality of Service (QoS) concept of LTE and Universal Mobile Telecommunications System (UMTS) technology. Details of the QoS concept for LTE can be found in the 3^{rd} Generation Project Partnership (3GPP) Technical Specification TS 23.410. The main idea of this concept is that services with different requirements use different bearers. When a User Equipment (UE) attaches to the network a default-bearer is established (typically a best-effort service). However, if the UE invokes services having different QoS parameters then a dedicated bearer is established for each service.

There is no common solution to provide efficient Radio Bearer (RB) level service differentiation over a Transport Network bottleneck. In International patent application No. PCT/EP2011/068023, the present inventors have described a mechanism for a per-bearer level service differentiation, that makes the bandwidth sharing among RBs more RAN-controlled. This is described further below in relation to FIG. 1. The mechanism employs the concept of “colour” profiling similar to that defined by the Metro Ethernet Forum (MEF) in MEF 23, Carrier Ethernet Class of Service—Phase 1 (See also http://metroethernetforum.org/PDF Documents/Bandwidth-Profiles-for-Ethernet-Services.pdf.). As a way of indicating which service frames (or data packets) are deemed to be within or outside of the Service Level Agreement (SLA) contract colours are assigned to the data packets according to the bandwidth profile. Note that there is no technical significance to the colour itself, which is just used as a convenient way of describing and/or labeling the data packets. Levels of compliance are green when fully compliant, yellow when sufficient compliance for transmission but without performance objectives and red or discarded when not compliant with either. The data packets of a bearer are checked against the compliance requirements by a bandwidth profiler, for example a two-rate, three-color marker. This validation process can be used between two parties (e.g. between two operators) and can be the part of the SLA. In general, in the SLA different requirements are set for green packets and yellow packets. The green packets are “more important” than the yellow packets. To reflect this difference between two types of packets, at a bottleneck point such as on entry to a TN, a colour aware active queue management discards yellow packets in preference to green packets when there is congestion (i.e. insufficient bandwidth available in the TN to transport all data packets). Thus, for each RB a predefined profiling rate (i.e. green rate) is assigned based on the Quality QoS Class Identifier (QCI) of the RB. This mechanism allows bandwidth guarantees to be provided for the RBs, at least to a certain degree.

Referring to FIG. 1, this shows a schematic illustration of a TN employing bandwidth profiling for each of two bearers. The example is shown of an LTE system with two bearers 102, 104 each carrying data packets between a PDN-GW 106 and an eNodeB 108 via a S-GW 110 and through a TN 112. The Bearers 102, 104 are designated S5/S8 bearers 102a, 104a between the PDN-GW 106 and the S-GW 110, S1 bearers 102b, 104b from the S-GW 110 over the TN 112, and radio bearers 102c, 104c beyond the eNodeB 108. Each Bearer is assigned a bandwidth profiler—profiler 114 for bearer 102 and profiler 116 for bearer 104. Each of the bearers has an assigned QCI and an associated predefined ‘green’ rate (CIR) and bucket size. This example is of a single rate, two-colour profiler as there is no ‘yellow’ rate set for the bearers. It will be appreciated that the principles applied to the two-colour profilers described herein could readily be extended to three or more colours, in which case an additional rate would be specified (referred to as an Extended Information Rate—EIR) for each additional colour used.

Packets of each Bearer 102, 104 that conform with the bearer's profiler 114, 116 are marked as conformant packets 118 (i.e. assigned ‘green’) and packets that do not conform are marked as non-conformant packets 120 (i.e. assigned ‘yellow’). All data packets that are not coloured ‘green’ by the profilers 114, 116 are assigned ‘yellow’. For example, assume that the ‘green rate’ is 5 Mbps for a Bearer and the bitrate of this Bearer is about 7.5 Mbps. In this case, approximately ⅓ of the packets of the Bearer will be assigned to ‘yellow’.

The TN 112 bottleneck active queue management can then use the colour information marked in the data packets when choosing which packets to drop when there is insufficient bandwidth (congestion). The first packets to be dropped will be the ‘yellow’ packets 120.

In the example described, a two-colour (green-yellow) profiler is used for each Bearer. When the profiler 114, 116 assigns a Packet either ‘green’ or ‘yellow’, this means that the packet is marked with the conformance information in such a way it can be used at the TN bottleneck buffer(s). For example the Drop Eligibility (DEI) bit of the packet's Ethernet frame, or the Differentiated Services Control Point (DSCP) field in the IP header could be used to indicate if a packet has been assigned ‘green’ or ‘yellow’.

Originally the colouring concept was used to implement a specific service agreement between two networks/operators. For example a Service Level Agreement (SLA) between two operators may specify the Committed Information Rate (CIR or green rate) and the Excess Information Rate (EIR rate that is the maximum acceptable rate). Roughly speaking the service is guaranteed for green packets whereas for yellow packets it is only a “best-effort” service. This means that the dropping of yellow packets does not violate the SLA.

This colouring concept can also be used for improving per-service or per-bearer fairness at a bottleneck, as described in PCT/EP2011/068023. In this case, the colouring concept is used in a different way, for a different purpose and at a different location (i.e. it is done in the RAN node instead of in the Mobile Back Haul, MBH, node). A green rate is assigned for a bearer (i.e. for a service of a user and roughly speaking a desired bitrate for that service) and data packets of the bearer that do not exceed this bitrate are coloured green, whereas data packets above the green rate are coloured yellow. In this case when a bearer has yellow packets that means that it has a higher bandwidth than the desired value (but gains from this higher bandwidth when the data packets are transported through the bottleneck), so the drop of these yellow packets probably does not have a serious negative impact on the service performance. Consequently, in this case the use of green and yellow packets improves the fairness of resource sharing among user services. Note that when the colouring concept is used for improving per-bearer fairness, then the colouring (i.e. profiling) is done in the RAN node where per-bearer handling is available.

In the above example, a static green rate configuration is used such that the profiler for each bearer uses a predefined green rate. The mechanism is implemented in a RAN node (e.g. Radio Network Controller, RNC, or Serving gateway, S-GW) and operates on a per-bearer basis. For example, if we would like to provide 1 Mbps bandwidth for a specific bearer, then we use a profiler for that bearer with a 1 Mbps green rate. A packet of the bearer will be coloured according to this, such that when the bearer bitrate is below 1 Mbps all packets of the bearer will be coloured to green. When the bitrate is over 1 Mbps some packets will be coloured yellow. At the transport network (TN) an Active Queue manager (AQM) uses colour aware dropping such that when there is insufficient capacity in the TN a yellow packet will be dropped first. This means that bearers that have yellow packets (i.e. their bitrate is above 1 Mbps) will suffer packet drops when there is congestion in the TN.

This static green rate setting can be used for a bearer (i.e. service) where the bandwidth requirement is known in advance—for example a streaming service. However, a relative service differentiation can be useful. For example to differentiate between a premium and a normal Internet access, then a premium user may get, say, 4 times more bandwidth than a normal user. In a High-Speed Downlink Packet Access (HSDPA) network this type of service differentiation is referred to as a Relative Bitrate (RBR) feature. As an option the static green rate setting can be used to approximate relative service differentiation. The static profiling rates for the bearers can be determined based on the typical TN link capacity and the typical traffic mix. However, the use of static green rates cannot provide relative service differentiation in all situations. In particular, a static profiling rate mechanism can only handle bottleneck capacity changes in per-bearer resource sharing to a limited extent by using more colours. Also, a static profiling rate mechanism cannot handle all traffic mixes, or where there are substantial changes in the traffic mix, in per-bearer resource sharing. This means that the existing mechanisms do not provide very efficient relative service differentiation.

In addition to this, use of a static green rate setting can not deal with resource sharing among different Radio Access Technologies (RATs—e.g. HS & LTE). This means that it can not deal with resource sharing among MBH services in controlled way. For example, at present, a TN may provide relative service differentiation among HS bearers and among LTE bearers, respectively (e.g. a gold HS bearer gets 2× more bandwidth share than a silver HS bearer, meanwhile a gold LTE bearer gets 2× more bandwidth share than a silver LTE bearer), but can only keep a predefined sharing arrangement between the aggregated traffic of an HS node and an LTE node (e.g. 50%-50%).

### SUMMARY

A first aspect provides a method of transporting data packets over a telecommunications transport network. The data packets are carried by a plurality of bearers, and are sent over the transport network from a serving node. Information is received relating to a current capacity of the transport network. A current maximum total information rate for the serving node is dynamically adjusted based on information relating to a current capacity of the transport network. A current maximum information rate for each of the bearers is determined based on the current maximum total information rate. Bandwidth profiling is applied to the data packets of each of the bearers, independently of the other bearers, to identify the data packets of each of the bearers that are conformant with the determined current maximum information rate for the bearer. The data packets are forwarded for transport through the transport network. If there is insufficient bandwidth available in the transport network, data packets not identified by the profiling as being conformant are discarded.

A second aspect provides a network entity of a telecommunications network configured as a serving node to provide data packets for transport through a transport network. The data packets are carried by a plurality of bearers, the bearers each carrying data packets that relate to different ones of a plurality of services. The network entity includes a bandwidth profiler for applying bandwidth profiling to the data packets of one or more of the bearers, independently of the other bearers, to identify data packets that are conformant with a maximum information rate for the bearer. The network entity is configured to forward the data packets to the transport network including an indication in each of the data packets as to whether it is a conformant data packet or is a non-conformant data packet. The network entity is also configured to receive information relating to a current capacity of the transport network; to dynamically adjust a current maximum total information rate for the serving node based on information relating to the current capacity of the transport network; and to determine a current maximum information rate for each of the bearers based on the current maximum total information rate.

Embodiments provide a mechanism to update per-bearer level profiling dynamically. Bearer profiling parameters can be updated dynamically when the bottleneck capacity is changed and/or when the traffic mix is changed (i.e. number of ongoing bearers is changed). The mechanism provides an improved relative service differentiation.

Furthermore, the mechanism provides for updating of the available information rate (green rate) of a node such that TN capacity can be shared between different RATs. Thus, where a TN is shared between different RATs, the available green rate of a node (RNC node or a S-GW node) is updated dynamically when the common TN bottleneck capacity is changed, or when required sharing among nodes is changed. The updated available green rate of a node may then be distributed between the individual bearers being handled by the node.

### BRIEF DESCRIPTION OF THE DRAWINGS

FIG. 1 is a schematic illustration of a TN employing a known per-bearer bandwidth profiling mechanism.

FIG. 2 is a schematic illustration of a TN employing dynamically adjustable per-bearer bandwidth profiling mechanism.

FIG. 3 is a flow diagram illustrating the principal steps in a method of dynamically adjustable per-bearer bandwidth profiling.

FIG. 4 is a block diagram illustrating functional components in a network entity configured for use with a dynamically adjustable per-bearer bandwidth profiling mechanism.

### DETAILED DESCRIPTION OF PREFERRED EMBODIMENTS

The embodiments described herein apply per-Bearer bandwidth profiling to control resource sharing among Bearers carrying different services. The embodiments employ a ‘colour’ profiling scheme of the type described above.

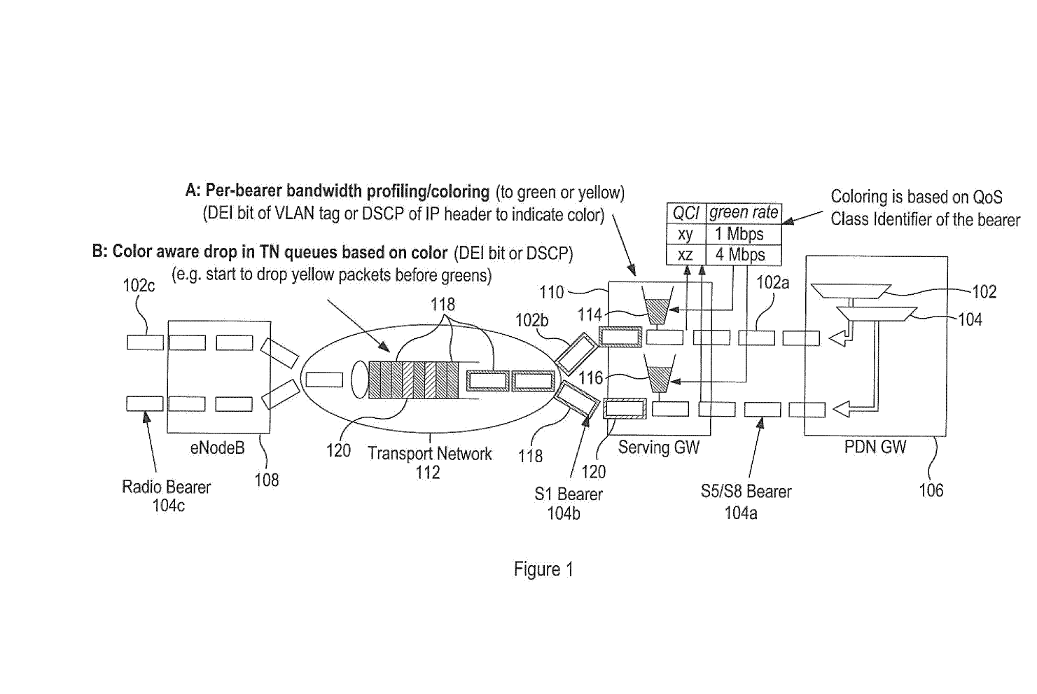

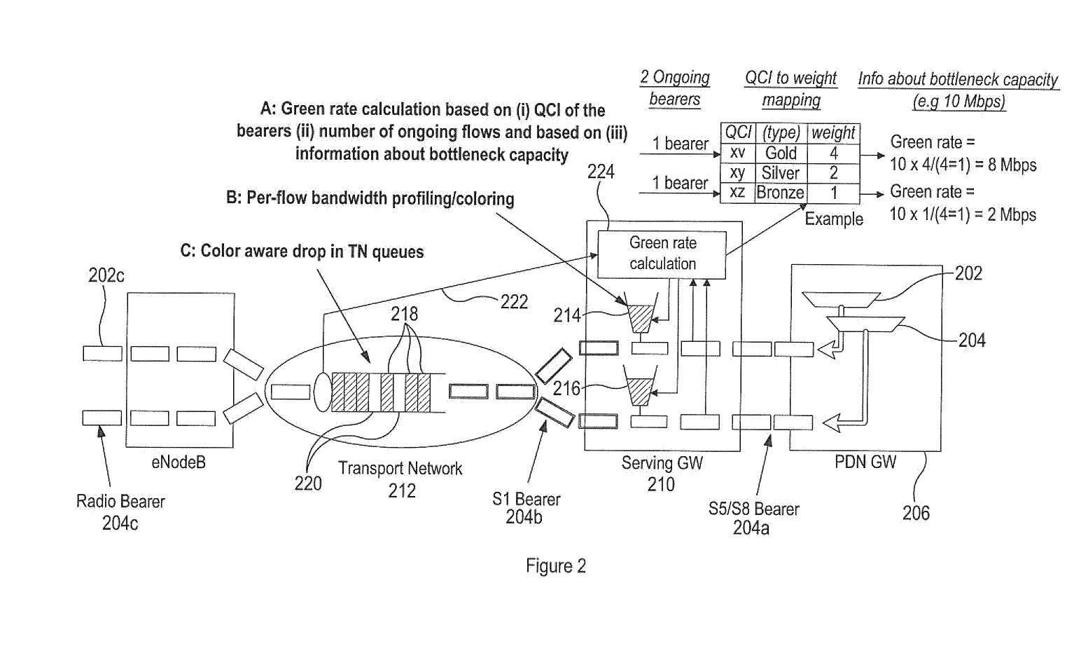

Referring to FIG. 2, this shows a schematic illustration of a TN employing bandwidth profiling for each of two bearers, similar to FIG. 1 described above. The example is shown of an LTE system with two bearers 202, 204 each carrying data packets between a PDN-GW 206 and an eNodeB 208 via a S-GW 210 and through a TN 212. As in FIG. 1, each Bearer is assigned a bandwidth profiler—profiler 214 for bearer 202 and profiler 216 for bearer 204. Each of the bearers has a QCI and a ‘green rate’ setting, which will be discussed further below. There is also a green rate calculation module 224 associated with the profilers 214, 216, from which the green rate for each bearer is determined, as will be explained in more detail below. The green rate calculation module 224 receives information relating to the current capacity of the TN bottleneck, as represented by the arrow 222.

Packets of each Bearer 202, 204 that conform with the green rate at the bearer's profiler 214, 216 are marked as conformant packets 218 (i.e. assigned ‘green’) and packets that do not conform are marked as non-conformant packets 220 (i.e. assigned ‘yellow’). Because this example is of a single rate, two-colour profiler there is no EIR or yellow rate set for the bearers. Therefore, all data packets that are not assigned ‘green’ by the profilers 214, 216 are assigned ‘yellow’.

In the example described, a two-colour (green-yellow) profiler is used for each Bearer. The TN 212 bottleneck active queue management can then use the colour information marked in the data packets when choosing which packets to drop when there is insufficient bandwidth (congestion). The first packets to be dropped will be the ‘yellow’ packets 220. It will be appreciated that the principles applied to the two-colour profilers described above could readily be extended to three or more colours, in which case an additional EIR would be specified for each additional colour used.

The green rate calculation module 224 provides a mechanism that operates at two levels. At one level the aggregated (available) green rate of a node (S-GW 210 in FIG. 2) is updated, while at another level the green rate for each bearer 202, 204 within a node is updated.

The available green rate for a node (i.e. green rate that can then be distributed among the bearers being served by the node) is updated when bottleneck capacity is changed or when the target bandwidth sharing among nodes (e.g. among the RATs using the TN) is changed. This requires the green rate calculation module 224 to obtain information about any changes in the TN bottleneck capacity.

One possibility (as depicted by the arrow 222 in FIG. 2) is for the green rate calculation module 222 to be notified of TN bottleneck capacity changes, for example using a message sent by a MBH node in the TN 212, such as an Ericsson™ microwave Minilink, which contains information about its actual capacity. The information has to be provided to the RAN node (e.g. S-GW 210 in FIG. 2, or RNC) where the per-bearer based profiling is done. This means that when a MBH node in the TN 212 generates this type of message and sends it to the MBH edge node, then this information needs to be forwarded to the RAN node as well. Note that the method is not limited to microwave equipment, but can be used in any network that is subject to capacity changes from time-to-time for whatever reason and is able to share the bottleneck capacity information with the serving nodes. Microwave links are but one example, which may include a weather-aware capacity (in bad weather conditions, the link capacity is decreased).

Another possibility it to use a query based approach. For example, a regular query may be sent from the RAN node to request information about the actual capacity of the TN bottleneck (e.g. query the actual modulation level of a MBH node such as a Minilink).

When the bottleneck is shared between multiple RAN nodes, then the total capacity can be distributed among these nodes, for example using an equal share (e.g. 50%-50% if there are two nodes) or using a load-dependent method where a node having a larger amount of traffic receives a larger fraction of the available green rate. This distribution can be statically configured in the nodes, e.g. each node is assigned a traffic-dependent weight that is used to determine its share of the capacity.

Alternatively the distribution can be done using communication between nodes. For example, communication among the nodes could be used to determine the sum of the weights of all the bearers in any given node. By comparing such weights of all the different nodes, the bandwidth share of each node can be determined. If communication about green rates is possible among nodes, then the nodes can negotiate the distribution of the bottleneck capacity according to a RAT sharing policy.

If communication about green rates between nodes (e.g. between RNC and S-GW sharing a common TN link) is not possible, or not desired, then a static distribution can be used, whereby each node is informed about the bottleneck capacity and multiplies this capacity with its own weight.

As an option over-allocating of green rates can be used, where the sum of the green rates of the nodes is higher than the bottleneck capacity. This option makes use of a multiplexing effect whereby at any given time the sum of the actual traffic is smaller than the sum of the maximum traffic (since not all RAN nodes generate the maximum traffic at the same time). This allows for some unused green rate at a node to be used by other nodes, without communication among nodes. It assumes that the probability that all nodes are operating at or above their green rate at the same time is very low, but on the rare occasions when that does occur, there will be some (small amount of) dropping of green packets.

As another option a yellow rate (EIR) can be set for each node, which is equal to the bottleneck link capacity. In this way each node has the potential to use the whole link capacity such that the data packets coloured yellow will be transported over the TN bottleneck when there is no (or very low) traffic from other nodes.

The mechanisms described above determine the green rate available at a node. Once a node's total available green rate has been set/updated this can be distributed among the ongoing bearers being handled by the node.

In one embodiment, the green rate of a node can be distributed among the ongoing bearers according to a targeted resource sharing policy. For relative service differentiation, for example, a high priority Gold bearer may be allocated 2 times more of the available green rate than a medium priority Silver bearer, and 4 times more then a low priority bronze bearer. In addition to this a minimum and/or a maximum green rate value for each bearer can be applied.

Each time the node starts handling traffic of a new bearer, each time the node ceases handling traffic of a bearer, and whenever there is a change in (total) green rate of the node, the green rate calculator 224 recalculates the green rates for each individual bearer according to the desired resource sharing policy. For example:

$$green rate of a bearer = \frac{total green rate of the node \times weight of the bearer}{sum of weights of all ongoing bearers}$$

After each recalculation the per-bearer profilers are updated in the RAN node.

A prohibit timer (or timers) may be used to avoid updating the green rates of each of the bearers too frequently. For example, a prohibit timer setting in the range 200 ms-1 sec might be used for green rate changes caused by arrival/departure of a bearer and a prohibit timer in the range 1-10 sec might be used for green rate changes caused by a TN bottleneck capacity change.

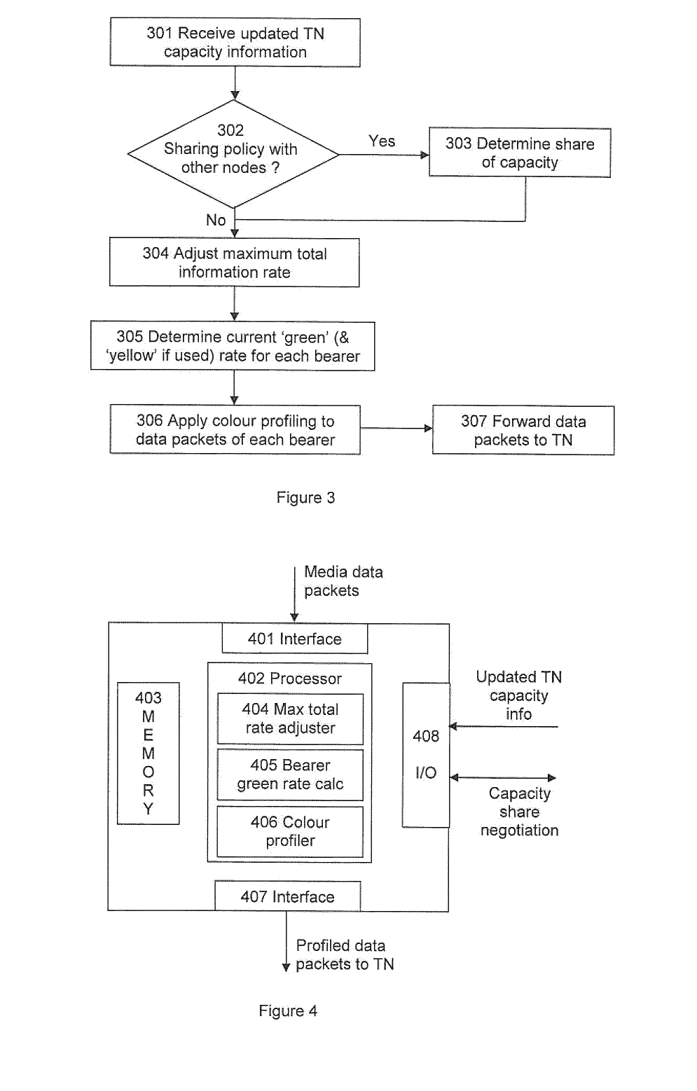

FIG. 3 is a flow chart illustrating the principal steps in a method of implementing the dynamic profiling mechanisms described above. At step 301a RAN node receives information containing an updated TN bottleneck capacity. At step 302, if the node is included in a sharing policy with other nodes that share the TN bottleneck link, then at step 303 a determination is made of the nodes share of the TN capacity. At step 304 the node adjusts its maximum available information rate (green rate). If at step 302 the node was not included in any sharing policy, then the adjustment will be based a static setting (e.g. fixed share of the total capacity). At step 305 a calculation is then made for the current green (and if used yellow) rates for each of the bearers that the node is handling. This may be in accordance with a sharing policy as described above. At step 306 the node starts applying the colour profiling to the data packets of each of the bearers in accordance with the recalculated green (and if used yellow) rates. At step 307 the profiled data packets are forwarded for transport over the TN.

FIG. 4 is a block diagram showing the principal functional components of a RAN entity (node) 400 applying the dynamic profiling mechanisms described above. The entity includes an interface 401 through which media data packets arrive, which are destined to be transported over a TN, and another interface 407 through which media data packets are forwarded on to the TN. The network entity 400 also includes a processor 402 and a memory 403 storing data and programming instructions for the processor. The processor 402 includes a maximum total rate adjuster 404, a per-bearer green rate calculator 405 and a colour bandwidth profiler 406. The network entity 400 also includes a, Input/Output 408 through which communications are sent or received to/from other nodes and from the TN regarding the updated TN capacity.

On receiving updated information relating to the current capacity of the TN, the maximum total rate adjuster 404 dynamically adjusts the current maximum total information rate for the node. The bearer green rate calculator 405 then determines a current maximum information rate (green rate) for each of the bearers based on the current maximum total information rate of the node. The colour profiler 406 applies bandwidth profiling to the data packets of each of the bearers using the calculated green rate, to identify and colour green data packets that are conformant with the maximum information rate for the bearer. The network entity 400 then forwards the colour profiled data packets through the other interface 407 to the transport network, and includes an indication in each of the data packets as to whether it is a conformant data packet (green) or is a non-conformant data packet (yellow).

Dynamically adjusting the rates for bandwidth profiling, as described above provides an improved mechanism for a fairer allocation of TN resources to bearers. The mechanisms allow for changing TN bottleneck capacity, and can be applied in a common TN serving different RATs, either with or without communication between RAT nodes (e.g. between RNC and S-GW).

1-20. (canceled)

21. A method of transporting data packets over a telecommunications transport network, wherein the data packets are carried by a plurality of bearers, and are sent over the transport network from a serving node, the method comprising:
receiving information relating to a current capacity of the transport network;
dynamically adjusting a current maximum total information rate for the serving node based on the information relating to the current capacity of the transport network;
determining a current maximum information rate for each of the bearers based on the current maximum total information rate;
applying bandwidth profiling to the data packets of each of the bearers, independently of the other bearers, to identify the data packets of each of the bearers that are conformant with the determined current maximum information rate for the bearer; and
forwarding the data packets for transport through the transport network, wherein if there is insufficient bandwidth available in the transport network, data packets not identified by the profiling as being conformant are discarded.

22. The method of claim 21, wherein the serving node is one of a plurality of serving nodes sending data packets over the transport network, and wherein the data packets of each bearer are sent over the transport network from one serving node of the plurality of serving nodes, the method further comprising:
dynamically adjusting a current maximum total information rate for each of the serving nodes based on the current capacity information received; and
applying said bandwidth profiling to the data packets of each of the bearers at the bearer's serving node.

23. The method of claim 22 wherein the dynamic adjustment of the current maximum total information rate for each of the serving nodes comprises distributing the current capacity of the transport network among the plurality of serving nodes.

24. The method of claim 23 wherein the current capacity of the transport network is distributed according to a predefined fixed distribution.

25. The method of claim 23 wherein the current capacity of the transport network is distributed according to a predefined sharing policy negotiated between the serving nodes.

26. The method of claim 23 wherein the sum of the adjusted maximum information rates of the serving nodes is greater than the current capacity of the transport network by a predetermined amount to allow for unused capacity at one serving node to be utilised by another serving node.

27. The method of claim 21, wherein the information relating to the current capacity of the transport network is provided in a notification signal sent to the serving node or serving nodes.

28. The method of claim 27 wherein the notification signal is provided in response to a query signal sent from the serving node.

29. The method of claim 27 wherein the notification signal is sent from a Mobile Backhaul, MBH, node in the transport network.

30. The method of claim 21, wherein the bandwidth profiling includes assigning the conformant data packets of a bearer as ‘green’ data packets based on the maximum information rate for the bearer and assigning other data packets that are not conformant as ‘yellow’.

31. The method of claim 30, further comprising defining an excess information rate of a bearer above the maximum information rate of the bearer and only assigning a data packet as ‘yellow’ if it is conformant with the excess information rate.

32. The method of claim 31, wherein the excess information rate of the bearer is defined as the current maximum total information rate for the serving node.

33. The method of claim 31, wherein the excess information rate of the bearer is defined as the current capacity of the transport network.

34. The method of claim 21, wherein the maximum information rate of each bearer served by a serving node is determined from the current maximum total information rate for the serving node in accordance with a predefined resource sharing policy.

35. The method of claim 34, wherein the resource sharing policy comprises an assigned weight value for each bearer, and the maximum information rate of a bearer is determined by multiplying the current maximum total information rate by the weight value as a proportion of the sum of the weight values of all the bearers served by the serving node.

36. The method of claim 21, wherein a prohibit timer is used to prevent too frequent re-determination of the maximum information rate of a bearer.

37. A network entity of a telecommunications network configured as a serving node to provide data packets for transport through a transport network, wherein the data packets are carried by a plurality of bearers, the bearers each carrying data packets that relate to different ones of a plurality of services, the network entity comprising:
one or more packet interfaces for receiving data packets and for forwarding data packets on to the transport network;
a communications interface for communicating with one or more other nodes in the telecommunications network; and
a processing circuit operatively associated with the one or more packet interfaces and the communications interface, and configured to:
apply bandwidth profiling to the data packets of one or more of the bearers, independently of the other bearers, to identify data packets that are conformant with a maximum information rate for the bearer;
forward the data packets to the transport network including an indication in each of the data packets as to whether it is a conformant data packet or is a non-conformant data packet;
receive information relating to a current capacity of the transport network;
dynamically adjust a current maximum total information rate for the serving node based on information relating to the current capacity of the transport network; and
determine a current maximum information rate for each of the bearers based on the current maximum total information rate.

38. The network entity of claim 37, being one of a plurality of serving nodes providing data packets for transport through the transport network and wherein the processing circuit is further configured to dynamically adjust the current maximum total information rate for the serving node in accordance with an information rate sharing policy among the plurality of serving nodes.

39. The network entity of claim 37, wherein the network entity is a Serving Gateway, S-GW, or a Packet Data Network Gateway, PDN-GW in a LTE network.

40. The network entity of claim 37, wherein the network entity is a Radio Network Controller, RNC, or a Gateway GPRS Support Node, GGSN, in a High-Speed Downlink Packet Access, HSDPA, network.
